(19) United States
(12) Patent Application Publication
(10) Pub. No.: US 2007/0043166 A1
(43) Pub. Date: Feb. 22, 2007

(54) Epoxy resin composition for encapsulating semiconductor chip and semiconductor device

(76) Inventor: Norihisa Hoshika, Tochigi (JP)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/343,268

(22) Filed: Jan. 30, 2006

(30) Foreign Application Priority Data
Jul. 29, 2004 (JP) P2004-221781
Jan. 28, 2005 (JP) P2005-021015
Jan. 28, 2005 (JP) P2005-021016

(51) Int. Cl. C08L 63/00

(52) U.S. Cl. 524/763; 525/396

(57) ABSTRACT

An epoxy resin composition for encapsulating a semiconductor chip having an improved flowability, an improved sequential moldability and the like, and additionally having improved characteristics of a cured product thereof, such as an improved mold-releaseability, an improved resistance to reflow soldering heat and the like, and a semiconductor device that is formed by encapsulating a semiconductor chip with the epoxy resin composition. An epoxy resin composition for encapsulating a semiconductor chip containing essential components of: (A) an epoxy resin, (B) a phenolic resin, (C) a cure accelerator, (D)an inorganic filler, (E) a mold releasing agent, (F) a silane coupling agent and (G) a chemical compound having aromatic ring that has hydroxyl groups, each of which is bound to respective two or more adjacent carbon atoms that composes the aromatic ring. At least one of said (A) epoxy resin and said (B) phenolic resin contains resin of novolac structure, in which biphenylene skeleton is included in its main chain, and said (E) mold releasing agent includes one or more chemical compound(s) selected from a group consisting of (E1) oxidized polyethylene wax, (E2) glycerin tri-fatty acid ester and (E3) oxidized paraffin wax, and further, said (E) mold releasing agent is contained in the amount of 0.01 wt % to 1 wt % both inclusive, and said (G)chemical compound is contained in the amount of 0.01 wt % to 1 wt % both inclusive, in the total epoxy resin composition.

This application is based on Japanese patent application Nos. 2005-021015 and 2005-021016, the contents of which are incorporated hereinto by reference.

### BACKGROUND

1. Technical Field

The present invention relates to an epoxy resin composition for encapsulating a semiconductor chip and a semiconductor device employing thereof. The present invention particularly relates to an epoxy resin composition for encapsulating a semiconductor chip, which has improved characteristics such as flowability, mold-releaseability and sequential moldability, and a semiconductor device employing thereof, which has an improved the resistance to reflow soldering heat.

2. Related Art

In recent years, levels of integration and surface mountability of semiconductor chips are increasing, under a situation where there are growing needs for achieving advanced functions and lighter, thinner and more compact bodies of electronic equipments. Based on such situation, it is the current status that requirements for epoxy resin compositions for encapsulating semiconductor chips growingly become more severe. In particular, as a level of a reduction in thickness of a semiconductor device is increased, stress may be generated due to an incomplete mold-releasing of a cured product of the epoxy resin composition from a metal mold. Such stress may cause a crack that are generated in the body of the semiconductor chip included in the semiconductor device and/or a reduced adhesiveness at the interface between the cured resin and the semiconductor chip. Consequently, an improved mold-releaseability for facilitating the release of the molded product (cured product), which is obtained from an epoxy resin composition, from the metal mold is required. Further, in view of a productivity, a nature for allowing molded products to be sequentially molded (in other words, sequential moldability) is required.

Further, in a situation that an environmental load is a critical issue, the type of solder is switched from lead-containing solder to lead-free solder. When lead-free solder is used, a temperature employed for solder processing is higher than a case using lead-containing solder, and thus much higher stress may be generated due to a vaporization of water contained in the semiconductor device. As such, the resistance to reflow soldering heat of a molded product, become more serious problem than in the conventional technology.

Accordingly, various proposals for improving the resistance to reflow soldering heat are made. For example, an epoxy resin composition containing a biphenyl epoxy resin, which is a low-viscous epoxy resin, mixed with an inorganic filler at higher filer-loading, is proposed (see Japanese Patent Laid-Open No. H05-131486 (P1-P9) and Japanese Patent Laid-Open No. H08-253555 (P2-P9)). Since such epoxy resin composition contains inorganic filler at higher filler-loading, flowability thereof is reduced. As such, a resistance to reflow soldering heat of a molded product is a trade-off with a flowability of an epoxy resin composition for encapsulating a semiconductor chip.

Therefore, there is a need for an epoxy resin composition for encapsulating a semiconductor chip having an improved flowability, an improved mold-releaseability, an improved sequential moldability and the like, and additionally having improved characteristics of a cured product thereof, such as an improved resistance to reflow soldering heat and the like, as well as a need for a semiconductor device that is formed by encapsulating a semiconductor chip with the epoxy resin composition.

### SUMMARY OF THE INVENTION

The present invention has been conceived in view of the foregoing situation, and it is an object of the present invention to provide an epoxy resin composition for encapsulating a semiconductor chip having an improved flowability, an improved mold-releaseability, an improved sequential moldability and the like, and additionally having improved characteristics of a cured product thereof, such as an improved resistance to reflow soldering heat and the like, and a semiconductor device that is formed by encapsulating a semiconductor chip with the epoxy resin composition.

According to one aspect of the present invention, there is provided:

(1] An epoxy resin composition for encapsulating a semiconductor chip, including:
(A) an epoxy resin;
(B) a phenolic resin;
(C) a cure accelerator;
(D) an inorganic filler;
(E) a mold releasing agent;
(F) a silane coupling agent; and
(G) a chemical compound having aromatic ring that has hydroxyl groups, each of which is bound to respective two or more adjacent carbon atoms that composes said aromatic ring,

wherein at least one of said (A) epoxy resin and said (B) phenolic resin contains a resin presented by the following general formula

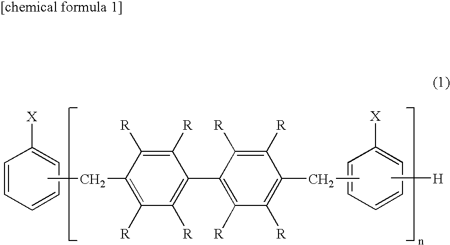

(wherein plurality of R, which are same or different, represent functional group(s) selected from a group consisting of hydrogen atom and alkyl groups having one to four carbon(s); X represents glycidyl lether group or hydroxyl group; and n represents an average value that is a positive number within a range of from 1 to 3),

wherein said (E) mold releasing agent includes one or more compound(s) selected from a group consisting of (E1) an oxidized polyethylene wax, (E2) a glycerin tri-fatty acid ester and (E3) an oxidized paraffin wax, and

wherein said (E) mold releasing agent is contained in the amount of 0.01 wt % to 1 wt % both inclusive, and said (G) chemical compound is contained in the amount of 0.01 wt % to 1 wt % both inclusive, in the total epoxy resin composition.

[2] The epoxy resin composition for encapsulating the semiconductor chip as described in [1], wherein said (G) chemical compound is presented by the following general formula (2):

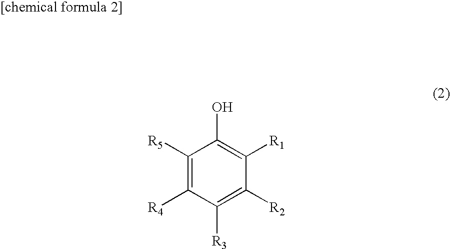

(wherein one of R1 and R5 is hydroxyl group, and the other is hydrogen atom, hydroxyl group or substitutional group other than hydroxyl group, each of R2, R3 and R4 is independently hydrogen atom, hydroxyl group or substitutional group other than hydroxyl group, or R2 and R3, R3 and R4 are combined to form aromatic ring).

[3] The epoxy resin composition for encapsulating the semiconductor chip as described in [1], wherein said (E) mold releasing agent is (E1) the oxidized polyethylene wax.

[4] The epoxy resin composition for encapsulating the semiconductor chip as described in [3], wherein a dropping point of said (E1) oxidized polyethylene wax is within a range of from 100° C. to 140° C. both inclusive.

[5] The epoxy resin composition for encapsulating the semiconductor chip as described in [3], wherein mean particle diameter of said (E1) oxidized polyethylene wax is within a range of from 20 μm to 70 μm both inclusive, and content of the particles having particle diameters of equal to or larger than 106 μm in the total (E1) oxidized polyethylene wax is equal to or less than 0.1 wt %.

[6) The epoxy resin composition for encapsulating the semiconductor chip as described in [3], wherein acid value of said (E1) oxidized polyethylene wax is within a range of from 10 mg KOH/g to 50 mg KOH/g both inclusive.

[7] The epoxy resin composition for encapsulating the semiconductor chip as described in [3], wherein number average molecular weight of said (E1) oxidized polyethylene wax is within a range of from 500 to 5,000 both inclusive.

[8] The epoxy resin composition for encapsulating the semiconductor chip as described in [3], wherein density of said (E1) oxidized polyethylene wax is within a range of from 0.94 g/cm³ to 1.03 g/cm³ both inclusive.

[9] The epoxy resin composition for encapsulating the semiconductor chip as described in [3], wherein said (E1) oxidized polyethylene wax includes one or more oxide(s) selected from a group consisting of: an oxide of a polyethylene wax produced via a low pressure polymerization process; an oxide of a polyethylene wax produced via a high pressure polymerization process; and an oxide of a high density polyethylene polymer.

[10] The epoxy resin composition for encapsulating the semiconductor chip as described in [1], wherein said (E) mold releasing agent is (E2) a glycerin tri-fatty acid ester.

[11] The epoxy resin composition for encapsulating the semiconductor chip as described in [10], wherein a dropping point of said (E2) glycerin tri-fatty acid ester is within a range of from 70° C. to 120° C. both inclusive.

[12] The epoxy resin composition for encapsulating the semiconductor chip as described in [10], wherein mean particle diameter of said (E2) glycerin tri-fatty acid ester is within a range of from 20 μm to 70 μm both inclusive, and content of the particles having particle diameters of equal to or larger than 106 pm. in the total (E2) glycerin tri-fatty acid ester is equal to or less than 0.1 wt % .

[13] The epoxy resin composition for encapsulating the semiconductor chip as described in [10], wherein acid value of said (E2) glycerin tri-fatty acid ester is within a range of from 10 mg KOH/g to 50 mg KOH/g both inclusive.

[14] The epoxy resin composition for encapsulating the semiconductor chip as described in [10], wherein said (E2) glycerin tri-fatty acid ester is a tri-ester compound of glycerin and saturated fatty acid having 24 to 36 carbon atoms.

[15] The epoxy resin composition for encapsulating the semiconductor chip as described in [1], wherein said (E) mold releasing agent is (E3) an oxidized paraffin wax.

[16] The epoxy resin composition for encapsulating the semiconductor chip as described in [15], wherein softening point of said (E3) oxidized paraffin wax is within a range of from 70° C. to 120° C. both inclusive.

[17] The epoxy resin composition for encapsulating the semiconductor chip as described in [15], wherein mean particle diameter of said (E3) oxidized paraffin wax is within a range of from 20 μm to 70 μm both inclusive, and content of the particles having particle diameters of equal to or larger than 106 μm. in the total oxidized paraffin wax is equal to or less than 0.1 wt % .

[18] The epoxy resin composition for encapsulating the semiconductor chip as described in [15], wherein acid value of said (E3) oxidized paraffin wax is within a range of from 10 mg KOH/g to 50 mg KOH/g both inclusive.

[19] A semiconductor device, provided by encapsulating a semiconductor chip with the epoxy resin composition for encapsulating the semiconductor chip as described in any of [1] to [18].

According to the present invention, an epoxy resin composition for encapsulating a semiconductor chip having an improved flowability,an improved mold-releaseability, an improved sequential moldability and the like, and also additionally having improved characteristics of a cured product thereof, such as an improved resistance to reflow soldering heat, a reduced water absorption and the like, is provided, as well as providing a semiconductor device that is formed by encapsulating a semiconductor chip with the epoxy resin composition.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

An epoxy resin composition for encapsulating a semiconductor chip according to the present invention contains the following component
(A) to component (G):
(A) an epoxy resin;
(B) a phenolic resin;
(C) a cure accelerator;
(D) an inorganic filler;
(E) a mold releasing agent;
(F) a silane coupling agent; and
(G) a chemical compound having aromatic ring that has hydroxyl groups, each of which is bound to respective two or more adjacent carbon atoms that composes the aromatic ring.

Further, in the epoxy resin composition for encapsulating the semiconductor chip of the present invention, the aforementioned (A) epoxy resin and the aforementioned (B) phenolic resin satisfy any of the requirements (i) to (iii) in the following general formula (1):

(i)the aforementioned (A) epoxy resin contains an epoxy resin that has glycidyl ether group represented by “X” in the following general formula (1);

(ii) the aforementioned (B) phenolic resin contains a phenolic resin that has hydroxyl group represented by “X” in the following general formula (1); and

(iii)both of the above-described requirements (i) and (ii) are satisfied,

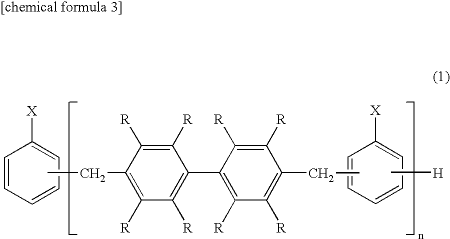

(where, in the above-described general formula (1), a plurality of R, which are same or different, represent a functional group selected from a group consisting of hydrogen atom and alkyl groups having one to four carbon(s); X represents glycidyl ether group or hydroxyl group; and n represents an average value that is a positive number within a range of from 1 to 3).

Further, the aforementioned (E) mold releasing agent includes one or more compound(s) selected from a group consisting of (E1) an oxidized polyethylene wax, (E2) a glycerin tri-fatty acid ester and (E3) an oxidized paraffin wax. Furthermore, aforementioned (E) mold releasing agent is contained in the amount of 0.01 wt % to 1 wt % both inclusive, and aforementioned (G) chemical compound is contained in the amount of 0.01 wt % to 1 wt % both inclusive, in the total epoxy resin composition.

The epoxy resin composition for encapsulating the semiconductor chip according to the present invention has the above-described formulation, so that the epoxy resin composition has an improved flowability, an improved mold-releaseability, an improved sequential moldability, which are critical factors for conducting a process for encapsulating the semiconductor chip, and additionally, the epoxy resin composition has improved characteristics of a cured product thereof, such as an improved resistance to reflow soldering heat, a reduced water absorption, a reduced stress, an improved adhesiveness with a metallic member and the like.

The epoxy resin composition for encapsulating the semiconductor chip according to the present invention (hereinafter, referred to as just “epoxy resin composition”) will be described in detail as follows.

<A) Epoxy Resin>

The (A) epoxy resin employed in the present invention preferably contains an epoxy resin that is represented by the following general formula (a), which is equivalent to the above-described general formula (1) as substituting “X” with glycidyl ether group:

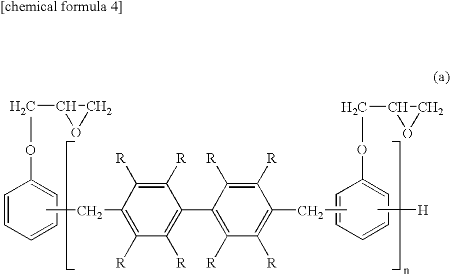

(wherein plurality of R, which are same or different, represent a functional group selected from a group consisting of hydrogen atom and alkyl groups having 1 to 4 carbon atoms; and n represents an average value that is a positive number within a range of from 1 to 3). In the general formula (a), it is more preferable that each of a plurality of R is hydrogen atom.

The epoxy resin represented by the above-described general formula (a) is hydrophobic structure-rich in resin molecular skeleton. Therefore, the cured product obtained from the epoxy resin composition containing such epoxy resin exhibits lower water absorption, so that a generation of higher stress due to a vaporization of water during a solder reflow can be inhibited. Further, since density of crosslinkages in the cured product is lower so that coefficient of elasticity at a temperature that is not lower than a glass-transition temperature is lower, thermal stress generated during a solder processing is reduced, resulting in providing an improved resistance to reflow soldering heat.

In the present invention, other type of epoxy resin may be additionally employed unless an advantageous effect obtainable by employing the epoxy resin represented by the above-described general formula (1) is not lost. Other type of epoxy resins may typically include, for example: phenol novolac type epoxy resins; creosol novolac type epoxy resins; biphenyl type epoxy resins; biphenol type epoxy resins; stilbene type epoxy resins; triphenolmethane type epoxy resins; phenol aralkyl (including phenylene-skeleton) type epoxy resins; naphthol type epoxy resins; alkyl-modified triphenolmethane type epoxy resins; triazine core-containing epoxy resins; dicyclopenta diene-modified phenol type epoxy resins or the like. The other type of epoxy resin may be employed alone, or in a form of a combination thereof.

When an epoxy resin of the above-described general formula (a)is not employed for the above-described (A) epoxy resin, the above-described other type of epoxy resins may alternatively be employed. In addition, when the epoxy resin of the above-described general formula(a) is not employed, it is preferable to employ a phenolic resin represented by a general formula (b), which will be discussed later, for the above-described (B) phenolic resin.

<(B) Phenolic Resin>

The (B) epoxy resin that is employed in the present invention preferably contains a phenolic resin that is represented by the following general formula (b), which is equivalent to the above-described general formula (1) as substituting “X” with hydroxyl group:

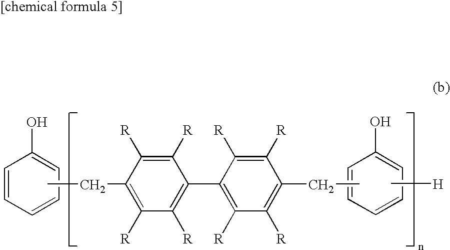

(wherein plurality of R, which are same or different, represent a functional group selected from a group consisting of hydrogen atom and alkyl groups having 1 to 4 carbon atoms; and n represents an average value that is a positive number within a range of from 1 to 3). In the general formula (b), it is more preferable that each of a plurality of R is hydrogen atom.

The phenolic resin represented by the above-described general formula (b) is in a hydrophobic structure-rich condition in resin molecular skeleton. Therefore, the cured product obtained from the epoxy resin composition containing such phenolic resin exhibits lower water absorption, so that a generation of higher stress due to a vaporization of water during a solder reflow can be inhibited. Further, since density of cross-linkages contained in molecular of the cured product is lower so that coefficient of elasticity is lower at a temperature of not lower than a glass-transition temperature, thermal stress generated during a solder processing is reduced, resulting in providing an improved resistance to reflow soldering heat.

In the present invention, other type of phenolic resin may be additionally employed unless an advantageous effect obtainable by employing the phenolic resin represented by the above-described general formula (b) is not lost. The other type of phenolic resins may typically include, for example: phenol novolac resins; creosol novolac resins; triphenolmethane resins; terpene-modified phenolic resins; dicyclopenta diene-modified phenolic resins; phenol aralkyl resins (including phenylene skeleton); naphthol aralkyl resins and the like. The other type of phenolic resin may be employed alone, or in a form of a combination thereof.

When a phenolic resin of the above-described general formula (b) is not employed for the above-described (B) phenolic resin, the above-described other type of phenolic resins may alternatively be employed. In addition, when the phenolic resin of the above-described general formula (b) is not employed, it is preferable to employ an epoxy resin represented by a general formula (a) as the above-described (A) epoxy resin.

Equivalent ratio of epoxy groups contained in the total epoxy resins employed in the present invention and phenolic hydroxyl group in all phenolic resins may be preferably within a range of from 0.5 to 2 both inclusive, and more preferably within a range of from 0.7 to 1.5 both inclusive. When the properties of the epoxy resin composition are within the above-described ranges, the epoxy resin composition has an improved cureability, and the cured product obtained from the composition has an improved moisture resistance.

<(C) Cure Accelerator>

Chemical compounds that are capable of being used for catalysts of cross-linking reaction between epoxy resin and phenolic resin may be employed for the (C) cure accelerator for the present invention. The (C) cure accelerators may typically include, for example: amine compounds such as tributyl amine, 1,8-diazabicyclo-(5,4,0)-undecene-7 and the like; organic phosphorus compounds such as triphenylphosphine, tetraphenylphosphonium tetraphenyl borate and the like; imidazole compounds such as 2-methyl imidazole and the like, though it is not intended to limit to these compounds. The cure accelerator may be employed alone, or in a form of a combination thereof.

<(D)Inorganic Filler>

The (D) inorganic filler employed in the present invention may typically include, for example, fused silica, crystalline silica, alumina, silicon nitride, aluminum nitride and the like. When particularly higher loading of the inorganic filler is intended, it is preferable to employ fused silica.

While either of crushed form or spherical form of fused silica may be employed, it is preferable to mainly employ spherical fused silica, in order to increase the filler-loading of fused silica and suppress an increase of melt viscosity of the epoxy resin composition. In order to further enhance the filler-loading of spherical silica, it is preferable to adjust spherical silica to have broader particle size distribution.

<(E) Mold Releasing Agent>

The (E) mold releasing agent employed in the present invention may typically include, for example: (E1) oxidized polyethylene wax;(E2) glycerin tri-fatty acid ester; and (E3) oxidized paraffin wax. The mold releasing agent may be employed alone, or in a form of a combination thereof.

The mold releasing agent will be described in sequence as follows.

((E1) Oxidized Polyethylene Wax)

Since the (E1) oxidized polyethylene wax generally has polar group composed of carboxylic acid or the like and nonpolar group composed of longer carbon chain, polar group is oriented in the side of the cured product of the resin and inversely, nonpolar group is oriented in the side of the metal mold, in the process for molding, thereby exhibiting a function of a mold releasing agent.

The content of oxidized polyethylene wax in the (E1) epoxy resin composition may be within a range of from 0.01 wt % to 1 wt % both inclusive, and preferably within a range of from 0.03 wt % to 0.5 wt % both inclusive. The content of oxidized polyethylene wax within the above-described range provides an improved mold-releaseability of the cured product from the metal mold. Further, such content of the wax provides an improved adhesiveness with a lead frame member, so that a separation of the cured product from the lead frame member can be inhibited in the solder processing. In addition, stain on the metal mold and/or degradation in appearance of the cured product caused in the molding process can be reduced.

The (E1) oxidized polyethylene waxes typically include: an oxide of a polyethylene wax produced via a low pressure polymerization process; an oxide of a polyethylene wax produced via a high pressure polymerization process; and an oxide of high density polyethylene polymer. Among these, high density polyethylene polymer may be more preferably employed. The oxidized polyethylene wax may be employed alone, or in a form of a combination thereof.

The following characteristics of the (E1) oxidized polyethylene wax, which are: (1-1) dropping point; (1-2) acid value; (1-3) number average molecular weight; (1-4) density; (1-5) mean particle diameter; and (1-6) content of particles having a diameter of not smaller than 106 μm, will be described in sequence.

(1-1)Dropping Point

The dropping point of the (E1) oxidized polyethylene wax is within a range of from 100° C. to 140° C. both inclusive, and preferably within a range of from 110° C. to 130° C. both inclusive. The dropping point can be measured by the method in accordance with ASTM D127. Concretely, it is measured as a temperature when the melting wax drops from a metallic nipple first. In the following examples, it is possible to measure it by a similar method.

The dropping point within the above-described range provides an improved thermal stability of the (E1) oxidized polyethylene wax, thereby preventing a burn-in of the (E1) oxidized polyethylene wax in the molding process. Therefore, an improved mold-releaseability of the cured product from metal mold is presented, as well as providing an improved sequential moldability. Further, the dropping point within the above-described range also provides sufficient melting of the (E1) oxidized polyethylene wax in the process for curing the epoxy resin composition. This provides substantially uniform dispersion of the oxidized polyethylene wax in the cured product.

Therefore, a segregation of the (E1) oxidized polyethylene wax on the surface of the cured product can be inhibited, thereby reducing the stain on the metal mold and the degradation in the appearance of the cured product.

(1-2) Acid Value

The acid value of the (E1) oxidized polyethylene wax is within a range of from 10 mg KOH/g to 50 mg KOH/g both inclusive, and preferably within a range of from 15 mg KOH/g to 40 mg KOH/g both inclusive. The acid value is influential in the compatibility in the cured product. Concretely, it is measured as a number of milligrams of potassium hydroxides that require to neutralize the unesterified fatty acid in the wax 1 g. In the following examples, it is possible to measure it by a similar method.

The acid value within the above-described range provides a preferable compatibility of the (E1) oxidized polyethylene wax with the epoxy resin matrix in the cured product. This prevents a phase separation of the (E1) oxidized polyethylene wax from the epoxy resin matrix. Therefore, a segregation of the (E1) oxidized polyethylene wax on the surface of the cured product is inhibited, thereby reducing the stain on the metal mold and the degradation in the appearance of the cured product.

Further, the presence of the (E1) oxidized polyethylene wax on the surface of the cured product provides an improved mold-releaseability of the cured product from the metal mold. On the contrary, excessively higher compatibility of the (E1) oxidized polyethylene wax with the epoxy resin matrix may prevent the (E1) oxidized polyethylene wax from leak on the surface of the cured product, resulting in insufficient mold-releaseability.

(1-3) Number Average Molecular Weight

The number average molecular weight of the (E1) oxidized polyethylene wax is within a range of from 500 to 5,000 both inclusive, and preferably within a range of from 1,000 to 4,000 both inclusive. For example, the number average molecular weight can be calculated by the polystyrene conversion using GPC apparatus such as HLC-8120 manufactured by Tosoh Corporation. In the following examples, it is possible to measure it by a similar method.

The number average molecular weight within the above-described range provides a preferable affinity state of the (E1) oxidized polyethylene wax with the epoxy resin matrix. Therefore, the cured product exhibits an improved mold-releaseability from the metal mold. On the contrary, excessively higher affinity of the (E1) oxidized polyethylene wax with the epoxy resin matrix may cause insufficient mold-releaseability.

Inversely, excessively lower affinity may cause a phase separation, thereby generating stains on the metal mold and a degradation in the appearance of the cured product of the resin.

(1-4) Density

The density of the (E1) oxidized polyethylene wax is within a range of from 0.94 g/cm³ to 1.03 g/cm3 both inclusive, an preferably within a range of from 0.97 g/cm³ to 0.99 g/cm³ both inclusive. The density can be calculated by measuring value at 20° C. in the floatation method in accordance with ASTM D1505. In the following examples, it is possible to measure it by a similar method.

The density within the above-described range provides an improved thermal stability of the (E1) oxidized polyethylene wax, thereby preventing a burn-in of the (E1) oxidized polyethylene wax in the molding process. Therefore, an improved mold-releaseability of the cured product from metal mold is presented, as well as providing an improved sequential moldability. Further, the density within the above-described range provides sufficient melting of the (E1) oxidized polyethylene wax in the process for curing the epoxy resin composition. This provides substantially uniform dispersion of the (E1) oxidized polyethylene wax in the cured product. Therefore, a segregation of the (E1) oxidized polyethylene wax on the surface of the cured product can be inhibited, thereby reducing the stain on the metal mold and the degradation in the appearance of the cured product.

(1-5) Mean Particle Diameter

The mean particle diameter is within a range of from 20 μm to 70 pm both inclusive, and preferably within a range of from 30 μm to 60 μm both inclusive. For example, the mean particle diameter is measured by using laser diffraction particle size analyzer such as SALD-7000 using water as solvent. In the following examples, it is possible to measure it by a similar method.

The mean particle diameter within the above-described range provides a preferable compatibility of the (E1) oxidized polyethylene wax with the epoxy resin matrix in the cured product. This provides a presence of the (E1) oxidized polyethylene wax on the surface of the cured product, thereby providing an improved mold-releaseability of the cured product from the metal mold. On the contrary, excessively higher compatibility thereof with the epoxy resin matrix may prevent the wax from leak on the surface of the cured product, resulting in insufficient mold-releaseability.

Further, since the (E1) oxidized polyethylene wax is in a state of a preferable compatibility with the epoxy resin matrix, a segregation of the (E1) oxidized polyethylene wax on the surface of the cured product can be inhibited, thereby reducing the stain on the metal mold and the degradation in the appearance of the cured product.

Furthermore, the mean particle diameter within the above-described range provides sufficient melting of the (E1) oxidized polyethylene wax in the process for curing the epoxy resin composition. Therefore, the resultant epoxy resin composition has an improved flowability.

(1-6) Content of Particles Having A Diameter of Not Smaller Than 106 μm

The content of particles having a diameter of not smaller than 106 μm in the total of the (E1) oxidized polyethylene wax may be preferably equal to or lower than 0.1 wt %. For example, this content is measured by using a standard sieve with screen size of 106 μm in accordance with JIS Z 8801. In the following examples, it is possible to measure it by a similar method.

The above-described content provides substantially uniform dispersion of the (E1) oxidized polyethylene wax, thereby reducing stain on the metal mold and degradation in the appearance of the cured product. Further, such content provides sufficient melting of the oxidized polyethylene wax in the process for curing the epoxy resin composition, thereby providing an improved flowability.

In the present invention, other type of mold releasing agent may be additionally employed unless an advantageous effect obtainable by employing the (E1) oxidized polyethylene wax is not lost. Other type of mold releasing agents may typically include, for example: natural waxes such as carnauba wax and the like; and metal salts of higher fatty acids such as zinc stearate and the like.

((E2) Glycerin Tri-Fatty Acid Ester)

The (E2) glycerin tri-fatty acid ester is a triester that can be obtained from glycerin and a saturated fatty acid. The presence of the(E2) glycerin tri-fatty acid ester in the epoxy resin composition provides much improved mold-releaseability of the cured product obtained from the composition. On the contrary, in the case of employing a monoester or a diester of glycerin and a saturated fatty acid, a moisture resistance of the cured product obtained from the epoxy resin composition is reduced, due to an influence of hydroxyl group remained therein, undesirably resulting in harmful effects in the resistance to reflow soldering heat.

The content of the (E2) glycerin tri-fatty acid ester in the epoxy resin composition is within a range of from 0.01 wt % to 1 wt % both inclusive, and preferably within a range of from 0.03 wt % to 0.5 wt % both inclusive. The content of glycerin tri-fatty acid ester within the above-described range provides an improved mold-releaseability of the cured product from the metal mold. Further, such content provides an improved adhesiveness with a lead frame member, such that separation of the cured product from the lead frame member can be inhibited in the solder processing.

In addition, stain on the metal mold and degradation in the appearance of the cured product can be reduced.

The (E2) glycerin tri-fatty acid esters typically include, for example: glycerin tri-caproic acid ester; glycerin tri-caprylic acid ester; glycerin tri-capric acid ester; glycerin trilaurin acid ester; glycerin tri-myristic acid ester; glycerin tripalmitin acid ester; glycerin tri-stearic acid ester; glycerin tri-arachic acid ester; glycerin tri-behenic acid ester; glycerin tri-lignoceric acid ester; glycerin tri-cerotic acid ester; glycerin tri-montanic acid ester; glycerin tri-melissic acid ester and the like. The glycerin tri-fatty acid ester may be employed alone, or in a form of a combination thereof.

Among these, glycerin tri-fatty acid ester of glycerin and saturated fatty acid having 24 to 36 carbon atoms may be preferably employed, in view of providing an improved mold-releaseability and an improved appearance of the molded product. Furthermore, glycerin tri-montanic acid ester may be more preferably employed. In the present invention, number of carbon atoms of saturated fatty acid is sum of number of carbon atoms in alkyl group and in carboxyl group of saturated fatty acid.

The following characteristics of the (E2) glycerin tri-fatty acid ester, which are: (2-1) dropping point; (2-2) acid value; (2-3) mean particle diameter; and (2-4) content of particles having adiameter of not smaller than 106 pm, will be described in sequence.

(2-1) Dropping Point

The dropping point of the (E2) glycerin tri-fatty acid ester is preferably within a range of from 70° C. to 120° C. both inclusive, and more preferably within a range of from 80° C. to 110° C. both inclusive.

The dropping point within the above-described range provides an improved thermal stability of the (E2) glycerin tri-fatty acid ester, thereby preventing a burn-in of the (E2) glycerin tri-fatty acid ester in the molding process. Therefore, an improved mold-releaseability of the cured product from a metal mold is presented, as well as providing an improved sequential moldability. Further, the dropping point within the above-described range provides sufficient melting of the (E2) glycerin tri-fatty acid ester in the process for curing the epoxy resin composition. This provides substantially uniform dispersion of the (E2) glycerin tri-fatty acid ester in the cured product. Therefore, a segregation of the (E2) glycerin tri-fatty acid ester on the surface of the cured product can be inhibited, thereby reducing stain on the metal mold and degradation in the appearance of the cured product.

(2-2) Acid Value

The acid value of the (E2) glycerin tri-fatty acid ester is within a range of from 10 mg KOH/g to 50 mg KOH/g both inclusive, and preferably within a range of from 15 mg KOH/g to 40 mg KOH/g both inclusive. The acid value is influential in the compatibility in the cured product.

The acid value within the above-described range provides a preferable compatibility of the (E2) glycerin tri-fatty acid ester with the epoxy resin matrix in the cured product. This prevents a phase separation of the (E2) glycerin tri-fatty acid ester from the epoxy resin matrix. Therefore, a segregation of the (E2) glycerin tri-fatty acid ester on the surface of the cured product is inhibited, thereby reducing stain on the metal mold and degradation in the appearance of the cured product.

Further, the presence of the (E2) glycerin tri-fatty acid ester on the surface of the cured product provides an improved mold-releaseability of the cured product from the metal mold. On the contrary, excessively higher compatibility thereof with the epoxy resin matrix may prevent the (E2) glycerin tri-fatty acid ester from leak on the surface of the cured product, resulting in insufficient mold releaseability.

(2-3) Mean Particle Diameter

The mean particle diameter is preferably within a range of from 20 μm to 70 μm both inclusive, and more preferably within a range of from 30 μm to 60 μm both inclusive.

The mean particle diameter within the above-described range provides a preferable compatibility of the (E2) glycerin tri-fatty acid ester with the epoxy resin matrix in the cured product. This provides a presence of the (E2) glycerin tri-fatty acid ester on the surface of the cured product, thereby providing an improved mold-releaseability of the cured product from the metal mold.

On the contrary, excessively higher compatibility thereof with the epoxy resin matrix may prevent the glycerin tri-fatty acid ester from leak on the surface of the cured product, resulting in insufficient mold-releaseability.

Further, since the (E2) glycerin tri-fatty acid ester is in a state of a preferable compatibility with the epoxy resin matrix, a segregation of the (E2) glycerin tri-fatty acid ester on the surface of the cured product can be inhibited, thereby reducing stain on the metal mold and degradation in the appearance of the cured product.

Furthermore, the mean particle diameter within the above-described range provides sufficient melting of the (E2) glycerin trifatty acid ester in the process for curing the epoxy resin composition.

Therefore, the resultant epoxy resin composition has an improved flowability.

(2-4) Content of Particles Having A Diameter of Not Smaller Than 106 μm

Further, content of particles having a diameter of not smaller than 106 μm in the total of the glycerin tri-fatty acid ester may be preferably equal to or lower than 0.1 wt % .

The above-described content provides substantially uniform dispersion of the (E2) glycerin tri-fatty acid ester in the epoxy resin composition, thereby reducing stain on the metal mold and degradation in the appearance of the cured product.

Further, such content provides sufficient melting of the oxidized polyethylene wax in the process for curing the epoxy resin composition, thereby providing an improved flowability.

The glycerin tri-fatty acid ester employed in the present invention may be obtained by adjusting particle size of a commercially available glycerin tri-fatty acid ester. In the present invention, other type of mold releasing agent may be additionally employed unless an advantageous effect obtainable by employing the glycerin tri-fatty acid ester is not lost.

Other type of mold releasing agents may typically include, for example: natural waxes such as carnauba wax and the like; and metal salts of higher fatty acids such as zinc stearate and the like.

((E3) Oxidized Paraffin Wax)

The (E3) oxidized paraffin wax is a generic name of oxides that are produced by air-oxidation of or acid-addition to a paraffin wax. A carboxyl group is introduced into a paraffin wax by conducting oxidization. The paraffin wax as the raw material is produced by a separation and a refinement of a distillate oil by reduced-pressure distillation, and is a solid wax at an ambient temperature. Normally, number of carbon atom in a molecular is on the order of 20 to 40 both inclusive, and molecular weight is on the order of 300 to 550 both inclusive.

The content of (E3) oxidized paraffin wax is within a range of from 0.01 wt % to 1 wt % both inclusive in the epoxy resin composition, and preferably within a range of from 0.03 wt % to 0.5 wt % both inclusive. The content thereof within the above-described range provides the cured product obtained from the epoxy resin composition exhibiting an improved mold-releaseability from the metal mold. Further, such content provides an improved adhesiveness with a lead frame member, such that separation of the cured product from the lead frame member can be inhibited in the solder processing. In addition, stain on the metal mold and degradation in the appearance of the cured product can be reduced.

The following characteristics of the (E3) oxidized paraffin wax, which are: (3-1) softening point; (3-2) acid value; (3-3) mean particle diameter; and (3-4) content of particles having a diameter of not smaller than 106 μm, will be described in sequence.

(3-1) Softening Point

Softening point of the (E3) oxidized paraffin wax is preferably within a range of from 70° C. to 120° C. both inclusive, and more preferably within a range of from 80° C. to 110° C. both inclusive. The softening point can be measure in accordance with JIS K-2235-5.3.1.

The softening point within the above-described range provides an improved thermal stability of the (E3) oxidized paraffin wax, thereby preventing a burn-in of the (E3) oxidized paraffin wax in the molding process. Therefore, an improved mold-releaseability of the cured product from a metal mold is presented, as well as providing an improved sequential moldability.

Further, the softening point within the above-described range provides sufficient melting of the (E3) oxidized paraffin,wax in the process for curing the epoxy resin composition. This provides substantially uniform dispersion of the (E3) oxidized paraffin wax in the cured product. Therefore, a segregation of the (E3) oxidized paraffin wax on the surface of the cured product can be inhibited, thereby reducing stain on the metal mold and degradation in the appearance of the cured product.

(3-2) Acid Value

The acid value thereof is within a range of from 10 mg KOH/g to 50 mg KOH/g both inclusive, and preferably within a range of from 15 mg KOH/g to 40 mg KOH/g both inclusive. The acid value is influential in the compatibility in the cured product.

The acid value within the above-described range provides a preferable compatibility of the (E3) oxidized paraffin wax with the epoxy resin matrix in the cured product. This prevents a phase separation of the (E3) oxidized paraffin wax from the epoxy resin matrix. Therefore, a segregation of the (E3) oxidized paraffin wax on the surface of the cured product is inhibited, thereby reducing stain on the metal mold and degradation in the appearance of the cured product.

Further, the presence of the (E3) oxidized paraffin wax on the surface of the cured product provides an improved mold-releaseability of the cured product from the metal mold.

On the contrary, excessively higher compatibility thereof with the epoxy resin matrix may prevent the wax from leak on the surface of the cured product, resulting in insufficient mold-releaseability.

(3-3) Mean Particle Diameter

The mean particle diameter is preferably within a range of from 20 μm to 70 μm both inclusive, and more preferably within a range of from 30 μm to 60 μm both inclusive.

The mean particle diameter within the above-described range provides a preferable compatibility of the (E3) oxidized paraffin wax with the epoxy resin matrix in the cured product. This provides a presence of the (E3) oxidized paraffin wax on the surface of the cured product, thereby providing an improved mold-releaseability of the cured product from the metal mold.

On the contrary, excessively higher compatibility thereof with the epoxy resin matrix may prevent the wax from leak on the surface of the cured product, resulting in insufficient mold-releaseability.

Further, since the (E3) oxidized paraffin wax is in a state of a preferable compatibility with the epoxy resin matrix, a segregation of the (E3) oxidized paraffin wax on the surface of the cured product can be inhibited, thereby reducing stain on the metal mold and degradation in the appearance of the cured product.

Furthermore, the mean particle diameter within the above-described range provides sufficient melting of the (E3) oxidized paraffin wax in the process for curing the epoxy resin composition. Therefore, the resultant epoxy resin composition has an improved flowability.

(3-4) Content of Particles Having A Diameter of Not Smaller Than 106 μm

Further, the content of particles having a diameter of not smaller than 106 μm in the total of the (E3) oxidized paraffin wax may be preferably equal to or lower than 0.1 wt % .

The above-described content provides substantially uniform dispersion of the (E3) oxidized paraffin wax composition, thereby reducing stain on the metal mold and degradation in the appearance of the cured product due to segregation of the (E3) oxidized paraffin wax. Further, such content provides sufficient melting of the (E3) oxidized paraffin wax in the process for curing the epoxy resin composition, thereby providing an improved flowability.

The (E3) oxidized paraffin wax employed in the present invention may be obtained by adjusting particle size of a commercially available glycerin tri-fatty acid ester. In the present invention, other type of mold releasing agent may be additionally employed unless an advantageous effect obtainable by employing the (E3) oxidized paraffin wax is not lost. Other type of mold releasing agents may typically include, for example: natural waxes such as carnauba wax and the like; and metal salts of higher fatty acids such as zinc stearate and the like.

<(F) Silane Coupling Agent>

The (F) silane coupling agent available in the present invention is not particularly limited, and a chemical compound that is capable of reacting with both of organic component such as epoxy resin or phenolic resin and inorganic filler to provide an improved interface strength therebetween may be employed. More specifically, the silane coupling agents available in the present invention may typically include epoxysilane, aminosilane, ureido silane, mercapto silane or the like. The (F) silane coupling agent may be employed alone, or in a form of a combination thereof. The (F) silane coupling agent is an essential component of the epoxy resin composition, which is capable of providing a considerably improved viscosity properties and flowing properties of the epoxy resin composition by a synergistic effect with the (G) chemical compound that will be discussed later.

Blending quantity of the (F) silane coupling agent employed in the present invention may be within a range of from 0.01 wt % to 1 wt % both inclusive in the total epoxy resin composition, preferably within a range of from 0.05 wt % to 0.8 wt % both inclusive, and more preferably within a range of from 0.1 wt % to 0.6 wt % both inclusive. The content of the silane coupling agent within the above-described range provides an improved effect, which is obtainable by employing the (G) chemical compound that will be discussed later, as well as providing an improved the resistance to reflow soldering heat in a semiconductor package.

Moreover, the use of the silane coupling agent at a content within the above-described range of the content allows providing a reduced water absorption of the epoxy resin composition, thereby providing an improved resistance to reflow soldering heat in a semiconductor package.

<(G)Chemical Compound Having Aromatic Ring That Has Hydroxyl Groups, Each Of Which is Bound To Respective Two or More Adjacent Carbon Atoms That Composes the Aromatic Ring>

The (G) chemical compound having aromatic ring that has hydroxyl groups, each of which is bound to respective two or more adjacent carbon atoms that composes the aromatic ring (hereinafter referred to as “(G) chemical compound”) available in the present invention may be a chemical compound represented by the following general formula (2):

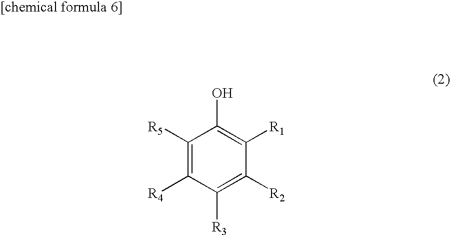

(wherein one of R1 and R5 is hydroxyl group, and the other is hydrogen atom, hydroxyl group or substitutional group other than hydroxyl group, each of R2, R3 and R4 is independently hydrogen atom, hydroxyl group, or R2 and R3 or R3 and R4 may be combined to form aromatic ring).

In the above-described formula (2), the chemical compound, which includes aromatic ring formed by combining R2 and R3 or R3 and R4, may be typically a chemical compound represented by the following general formula (3):

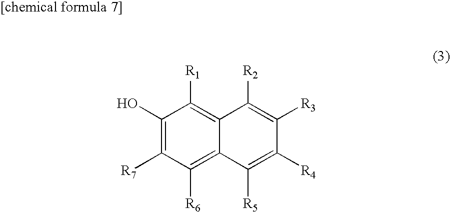

(wherein one of R1 and R7 is hydroxyl group, and the other is hydrogen atom, hydroxyl group or substitutional group other than hydroxyl group, and each of R2, R3, R4, R5 and R6 is independently hydrogen atom, hydroxyl group or substitutional group other than hydroxyl group).

The (G) chemical compounds available in the present invention may typically include, for example: catechol; pyrogallol; gallic acid; gallic acid ester; 1,2-dihydroxynaphthalene; 2,3-dihydroxynaphthalene; and derivatives thereof. The chemical compound may be employed alone, or in a form of a combination thereof.

Among these, 1,2-dihydroxynaphthalene, 2,3-dihydroxynaphthalene and derivatives thereof, which have a naphthalene ring as parents, may be more preferably employed, in view of facilitating controls in the flowability and the curing condition and providing lower volatility.

Blending quantity of the (G) chemical compound may be within a range of from 0.01 wt % to 1 wt % both inclusive in the total epoxy resin composition, preferably within a range of from 0.03 wt % to 0.8 wt % both inclusive, and more preferably within a range of from 0.05 wt % to 0.5 wt % both inclusive. The content of the (G) chemical compound within the above-described range provides viscosity properties and flowing properties thereof by a synergistic effect with the (F) silane coupling agent. Further, improved physical properties of the cured product thereof can be obtained, and therefore the compound can be preferably employed as the epoxy resin composition of the present invention.

While the epoxy resin composition for encapsulating the semiconductor chip of the present invention contains the aforementioned components (A) to (G) as essential components, the following other additives may also be additionally employed as required. Other additives may typically include, for example: fire retardant agents such as brominated epoxy resins, antimony trioxide, phosphorus compounds, metal hydroxides and the like; colorants such as carbon black, red ocher and the like; stress-reducing agent such as silicone oil, silicone rubber, synthetic rubber and the like; and antioxidants such as bismuth oxide hydrate and the like.

The epoxy resin composition for encapsulating the semiconductor chip of the present invention is produced by mixing the aforementioned components (A) to (G). More specifically, the components (A) to (G)and other additives are mixed by using a mixer or the like, and then the mixed material is heated and kneaded by using a heating kneader, a heat roll, a extruder or the like, and subsequently, the kneaded material is cooled, and then crushed to obtain the compound.

E1ectronic parts such as semiconductor chips can be encapsulated by using the epoxy resin composition for encapsulating the semiconductor chips according to the present invention to form a semiconductor device.

The encapsulation of the electronic parts such as the semiconductor chips can be conducted by curing and molding the compound via a conventional process such as, for example, a transfer molding process, compression molding process, injection molding process and the like.

It is apparent that the present invention is not limited to the above embodiment, that may be modified and changed without departing from the scope and spirit of the invention.

### EXAMPLES

The present invention will be further specifically described in reference to examples as follows, though it is not intended to limit the scope of the present invention thereto.

The compositions are presented by using part by weight.

### Example A

### Example a1

Following raw materials were employed in example a1:

Epoxy resin represented by the following general formula (4) (phenol aralkyl type epoxy resin having biphenylene skeleton), [commercially available from Nippon Kayaku Co, Ltd., under the trade name of “NC3000P”, having softening point of 58° C. and epoxy equivalent of 273]

7.36 parts by weight;

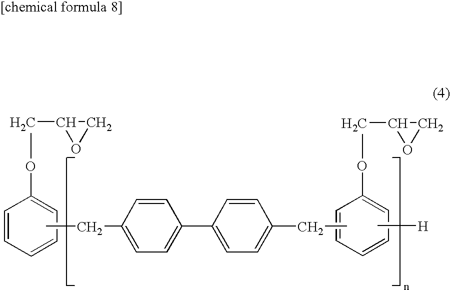

(n represents an average value that is a positive number within a range of from 1 to 3)

Phenolic resin of formula (5) (phenol aralkyl resin having phenylene skeleton [commercially available from Mitsui chemical Co., Ltd., under the trade name of XLC-4L, softening point of 65° C. and hydroxyl equivalent of 174]

4.69 parts by weight

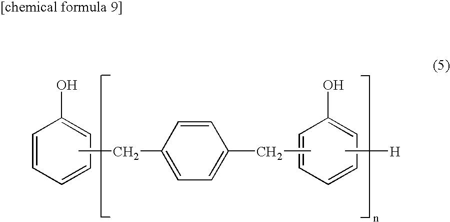

(n represents an average value that is a positive number within a range of from 1 to 3)

1,8-diazabicyclo-(5,4,0)-undecene -7(hereinafter, referred to as “DBU”)

0.20 parts by weight;

fused spherical silica (having mean particle diameter of 30.0 μm

87.00 parts by weight;

Oxidized polyethylene wax No. 1 (having dropping point of 120° C., acid value of 20 mg KOH/g, number average molecular weight of 2,000, density of 0.98 g/cm³, mean particle diameter of 45 μm, content of particles having diameter of not smaller than 106 μm of 0.0 wt % , oxide of high density polyethylene polymer) 0.10 part by weight;

y-glycidyl propyl trimethoxysilane

0.30 part by weight;

2,3-dihydroxynaphthalene (reagent)

0.05 part by weight; and

carbon black

0.30 part by weight.

After mixing the raw materials listed above by using a mixer, the mixed material was kneaded for 20 times by using a biaxial roll having surface temperatures of 95° C. and 25° C., and thereafter, the obtained sheet of the kneaded material was cooled and then was crushed to obtain an epoxy resin composition. The characteristics of the obtained epoxy resin composition was evaluated by the following method.

Results are shown in Table 1.

(Method for Evaluation)

Spiral Flow: A metal mold for measuring spiral flow pursuant to EMMI-1-66 was employed to conduct measurements at a metal mold temperature of 175° C., at an injection pressure of 6.9 MPa, and for curing time of 120 seconds. The obtained spiral flow is presented by an unit of cm.

Gold Wire Deformation Ratio: A 160 p low profile quad flat package (LQFP) (Cu L/F; package outer dimension: 24 mm×24 mm×1.4 mm-thick; pad size: 8.5 mm×8.5 mm; and chip size: 7.4 mm×7.4 μm) was molded by employing a low pressure transfer automated molding machine, at a metal mold temperature of 175° C., at an injection pressure of 9.6 MPa, and for a curing time of 70 seconds. The molded 160p LQFP (package) was observed with a soft X-ray fluoroscopy apparatus, and the obtained deformation ratio of the gold wire was expressed in ratio of (flow quantity) /(gold wire length). The criteria were that “o” (good) for the obtained deformation ratio of lower than 5% and “x” (bad) for the obtained deformation ratio of not lower than 5%.

Sequential Moldability: 500 shots of 80 p quad flat packages (QFP) (Cu L/F; package outer dimension: 14 mm×20 mm×2 mm-thick; pad dimension: 6.5 mm×6.5 mm; and chip dimension: 6.0 mm×6.0 mm) were sequentially molded by employing a low pressure transfer automated molding machine, at a metal mold temperature of 175° C., at an injection pressure of 9.6 MPa, and for a curing time of 70 seconds. The criteria were that “o” (good) for being successful in straight 500 shots without any problem such as poor injection and the like, and “x” (bad) for other results.

Appearance of Cured Material And Stain on Metal Mold: A stain was evaluated by a visual observation for a package and a metal mold after straight 500-shots had been completed in the above-described sequential molding process. The criteria for appearance of the cured product and the stain on the metal mold were that “x” (bad) for stained body, and “o” (good) for being not stained until straight 500-shots of moldings were completed.

Resistance To Reflow Soldering Heat: The package, which had been molded for the evaluation on the above-described sequential moldability was post-cured at 175° C. and for 8 hours, and the post-cured package was stored in a humid environment at 85° C. and in relative humidity of 85° for 168 hours, and then, IR reflow was processed to the humidity-processed package (260° C., JEDEC-Level 1). The package is observed with a microscope, and a crack generation rate [(crack generation rate)=((number of packages having external crack generation)/(number of total packages))×100] was calculated. The crack generation rate was presented by unit of %.20 packages were evaluated. In addition, adherence condition at an interface of the semiconductor chip with the epoxy resin composition was observed by an ultrasonic testing equipment. Twenty packages were evaluated. The criteria for resistance to reflow soldering heat were that “o” (good) for 0% of crack generation rate and no separation, and “x” (bad) for generating crack or separation.

### Examples a2 to a23, and Comparative Examples a1 to a9

Respective components were mixed by the ratio described in table 1, table 2 and table 3, and epoxy resin compositions were obtained in similar way as in example a1, and evaluations thereof were conducted in similar way as in example a1. Results are shown in table 1, table 2 and table 3.

Components employed in examples other than example a1 will be described as follows.

Phenolic resin of the following formula (6) (phenol aralkyl resin having biphenylene skeleton) [commercially available from Meiwa Plastic Industries Co., Ltd., under the trade name of “MEH7851SS”, softening point of 67° C., and hydroxyl equivalent of 203]

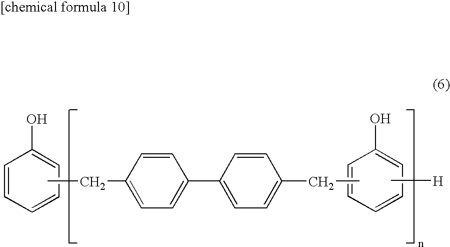

Epoxy resin of the following formula (7) (biphenyl type epoxy resin);

[commercially available from Japan epoxy resin Co., Ltd., under the trade name of YX-4000H”, melting point of 105° C., epoxy equivalent of 191]

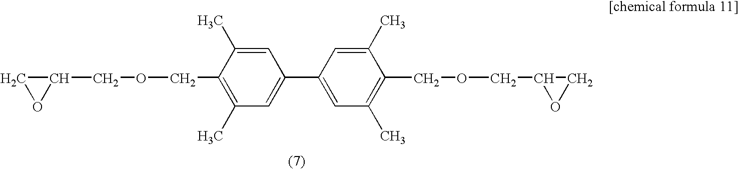

Oxidized polyethylene wax No. 2; (having dropping point of 105° C., acid value of 20 mg KOH/g, number average molecular weight of 1,100, density of 0.97 g/cm³, mean particle diameter of 45 pm, content of particles having diameter of not smaller than 106 μm of 0.0 wt % , oxide of polyethylene wax produced via low pressure polymerization process).

Oxidized polyethylene wax No. 3; (having dropping point of 135° C., acid value of 25 mg KOH/g, number average molecular weight of 3,000, density of 0.99 g/cm³, mean particle diameter of 40 μm, content of particles having diameter of not smaller than 106 μm of 0.0 wt % , oxide of high density polyethylene polymer).

Oxidized polyethylene wax No. 4; (having dropping point of 110° C., acid value of 12 mg KOH/g, number average molecular weight of 1,200, density of 0.97 g/cm³, mean particle diameter of 50 μm, content of particles having diameter of not smaller than 106 μm of 0.0 wt % , oxide of high density polyethylene polymer).

Oxidized polyethylene wax No. 5; (having dropping point of 110° C., acid value of 45 mg KOH/g, number average molecular weight of 2,000, density of 0.97 g/cm³, mean particle diameter of 45 μm, content of particles having diameter of not smaller than 106 μm of 0.0 wt % , oxide of polyethylene wax produced via high pressure polymerization process).

Oxidized polyethylene wax No. 6; (having dropping point of 110° C., acid value of 20 mg KOH/g, number average molecular weight of 750, density of 0.98 g/cm³, mean particle diameter of 45 pm, content of particles having diameter of not smaller than 106 μm of 0.0 wt % , oxide of high density polyethylene polymer).

Oxidized polyethylene wax No. 7; (having dropping point of 130° C., acid value of 20 mg KOH/g, number average molecular weight of 4,500, density of 0.99 g/cm³, mean particle diameter of 45 μm, content of particles having diameter of not smaller than 106 μm of 0.0 wt % , oxide of polyethylene wax produced via high pressure polymerization process).

Oxidized polyethylene wax No. 8; (having dropping point of 110° C., acid value of 20 mg KOH/g, number average molecular weight of 1,100, density of 0.95 g/cm³, mean particle diameter of 45 μm, content of particles having diameter of not smaller than 106 μm of 0.0 wt % , oxide of polyethylene wax produced via low pressure polymerization process).

Oxidized polyethylene wax No. 9; (having dropping point of 110° C., acid value of 25 mg KOH/g, number average molecular weight of 2,000, density of 1.02 g/cm³, mean particle diameter of 45 μm, content of particles having diameter of not smaller than 106 μm of 0.0 wt % , oxide of high density polyethylene polymer).

Oxidized polyethylene wax No. 10; (having dropping point of 120° C., acid value of 20 mg KOH/g, number average molecular weight of 2,000, density of 098 g/cm³, mean particle diameter of 30 μm, content of particles having diameter of not smaller than 106 μm of 0.0 wt % , oxide of high density polyethylene polymer).

Oxidized polyethylene wax No. 11; (having dropping point of 120° C., acid value of 20 mg KOH/g, number average molecular weight of 2,000, density of 0.98 g/cm³ mean particle diameter of 60 μm, content of particles having diameter of not smaller than 106 μm of 0.0 wt % , oxide of high density polyethylene polymer).

Polyethylene wax No. 1; (having dropping point of 135° C., acid value of 0 mg KOH/g, number average molecular weight of 5,500, density of 0.93 g/cm³, mean particle diameter of 45 μm, content of particles having diameter of not smaller than 106 μm of 0.0 wt %, polyethylene wax produced via low pressure polymerization process).

Polyethylene wax No. 2; (having dropping point of 115° C., acid value of 0 mg KOH/g, number average molecular weight of 1,800, density of 0.93 g/cm³, mean particle diameter of 45 μm, content of particles having diameter of not smaller than 106 μm of 0.0 wt %, polyethylene wax produced via high pressure polymerization process).

1,2-dihydroxynaphthalene (reagent)

catechol (reagent)

pyrogallol (reagent)

1,6-dihydroxynaphthalene (reagent)

resorcinol (reagent).

TABLE 1

| | EXAMPLES | | | | | | |
|---|---|---|---|---|---|---|---|
| | a1 | a2 | a3 | a4 | a5 | a6 | a7 |
| EPOXY RESIN OF FORMULA (4) | 7.36 | | 6.91 | 6.92 | 6.88 | 6.80 | 6.65 |
| EPOXY RESIN OF FORMULA (7) | | 5.84 | | | | | |
| PHENOLIC RESIN OF FORMULA (6) | | 6.21 | 5.14 | 5.15 | 5.12 | 5.05 | 4.95 |
| PHENOLIC RESIN OF FORMULA (5) | 4.69 | | | | | | |
| DBU | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 |
| OXIDIZED POLYETHYLENE WAX No. 1 | 0.10 | 0.10 | 0.10 | 0.10 | 0.10 | 0.10 | 0.10 |
| γ-GLYCIDYLPROPYLTRIMETHOXYSILANE | 0.30 | 0.30 | 0.30 | 0.30 | 0.30 | 0.30 | 0.30 |
| 2,3-DIHYDROXYNAPHTHALENE | 0.05 | 0.05 | 0.05 | 0.03 | 0.10 | 0.25 | 0.50 |
| 1,2-DIHYDROXYNAPHTHALENE | | | | | | | |
| CATECHOL | | | | | | | |
| PYROGALLOL | | | | | | | |
| CARBON BLACK | 0.30 | 0.30 | 0.30 | 0.30 | 0.30 | 0.30 | 0.30 |
| SPIRAL FLOW (cm) | 125 | 105 | 110 | 100 | 120 | 125 | 135 |
| GOLD WIRE DEFORMATION RATIO | 0 | 0 | 0 | 0 | 0 | 0 | 0 |
| SEQUENTIAL MOLDABILITY | 0 | 0 | 0 | 0 | 0 | 0 | 0 |
| STAIN ON METAL MOLD SURFACE | 0 | 0 | 0 | 0 | 0 | 0 | 0 |
| STAIN ON MOLDED PRODUCT SURFACE | 0 | 0 | 0 | 0 | 0 | 0 | 0 |
| RESISTANCE TO REFLOW SOLDERING | 0 | 0 | 0 | 0 | 0 | 0 | 0 |
| HEAT | | | | | | | |

| | EXAMPLES | | | | | |
|---|---|---|---|---|---|---|
| | a8 | a9 | a10 | a11 | a12 | a13 |
| EPOXY RESIN OF FORMULA (4) | 6.48 | 6.91 | 6.91 | 6.91 | 6.95 | 6.51 |
| EPOXY RESIN OF FORMULA (7) | | | | | | |
| PHENOLIC RESIN OF FORMULA (6) | 4.82 | 5.14 | 5.14 | 5.14 | 5.18 | 4.84 |
| PHENOLIC RESIN OF FORMULA (5) | | | | | | |
| DBU | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 |
| OXIDIZED POLYETHYLENE WAX No. 1 | 0.10 | 0.10 | 0.10 | 0.10 | 0.02 | 0.80 |
| γ-GLYCIDYLPROPYLTRIMETHOXYSILANE | 0.30 | 0.30 | 0.30 | 0.30 | 0.30 | 0.30 |
| 2,3-DIHYDROXYNAPHTHALENE | 0.80 | | | | 0.05 | 0.05 |
| 1,2-DIHYDROXYNAPHTHALENE | | 0.05 | | | | |
| CATECHOL | | | 0.05 | | | |
| PYROGALLOL | | | | 0.05 | | |
| CARBON BLACK | 0.30 | 0.30 | 0.30 | 0.30 | 0.30 | 0.30 |
| SPIRAL FLOW (cm) | 150 | 105 | 115 | 120 | 115 | 95 |
| GOLD WIRE DEFORMATION RATIO | 0 | 0 | 0 | 0 | 0 | 0 |
| SEQUENTIAL MOLDABILITY | 0 | 0 | 0 | 0 | 0 | 0 |
| STAIN ON METAL MOLD SURFACE | 0 | 0 | 0 | 0 | 0 | 0 |
| STAIN ON MOLDED PRODUCT SURFACE | 0 | 0 | 0 | 0 | 0 | 0 |
| RESISTANCE TO REFLOW SOLDERING | 0 | 0 | 0 | 0 | 0 | 0 |
| HEAT | | | | | | |

TABLE 2

| | EXAMPLES | | | | | | | | | |
|---|---|---|---|---|---|---|---|---|---|---|
| | a14 | a15 | a16 | a17 | a18 | a19 | a20 | a21 | a22 | a23 |
| EPOXY RESIN OF FORMULA (4) | 6.91 | 6.91 | 6.91 | 6.91 | 6.91 | 6.91 | 6.91 | 6.91 | 6.91 | 6.91 |
| PHENOLIC RESIN OF FORMULA (6) | 5.14 | 5.14 | 5.14 | 5.14 | 5.14 | 5.14 | 5.14 | 5.14 | 5.14 | 5.14 |
| DBU | 0.20 | 0.20 | 0.20 | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 | 87.00 | 87.00 | 87.00 |
| OXIDIZED POLYETHYLENE WAX No. 2 | 0.10 | | | | | | | | | |
| OXIDIZED POLYETHYLENE WAX No. 3 | | 0.10 | | | | | | | | |
| OXIDIZED POLYETHYLENE WAX No. 4 | | | 0.10 | | | | | | | |
| OXIDIZED POLYETHYLENE WAX No. S | | | | 0.10 | | | | | | |
| OXIDIZED POLYETHYLENE WAX No. 6 | | | | | 0.10 | | | | | |
| OXIDIZED POLYETHYLENE WAX No. 7 | | | | | | 0.10 | | | | |
| OXIDIZED POLYETHYLENE WAX No. 8 | | | | | | | 0.10 | | | |
| OXIDIZED POLYETHYLENE WAX N0. 9 | | | | | | | | 0.10 | | |
| OXIDIZED POLYETHYLENE WAX No. 10 | | | | | | | | | 0.10 | |
| OXIDIZED POLYETHYLENE WAX No. 11 | | | | | | | | | | 0.10 |
| γ-GLYCIDYLPROPYLTRIMETHOXYSILANE | 0.30 | 0.30 | 0.30 | 0.30 | 0.30 | 0.30 | 0.30 | 0.30 | 0.30 | 0.30 |
| 2,3-DIHYDROXYNAPHTHALENE | 0.05 | 0.05 | 0.05 | 0.05 | 0.05 | 0.05 | 0.05 | 0.05 | 0.05 | 0.05 |
| CARBON BLACK | 0.30 | 0.30 | 0.30 | 0.30 | 0.30 | 0.30 | 0.30 | 0.30 | 0.30 | 0.30 |
| SPIRAL FLOW (cm) | 115 | 100 | 110 | 110 | 110 | 105 | 110 | 110 | 110 | 105 |
| GOLD WIRE DEFORMATION RATIO | 0 | 0 | 0 | 0 | 0 | 0 | 0 | 0 | 0 | 0 |
| SEQUENTIAL MOLDABILITY | 0 | 0 | 0 | 0 | 0 | 0 | 0 | 0 | 0 | 0 |
| STAIN ON METAL MOLD SURFACE | 0 | 0 | 0 | 0 | 0 | 0 | 0 | 0 | 0 | 0 |
| STAIN ON MOLDED PRODUCT SURFACE | 0 | 0 | 0 | 0 | 0 | 0 | 0 | 0 | 0 | 0 |
| RESISTANCE TO REFLOW SOLDERING HEAT | 0 | 0 | 0 | 0 | 0 | 0 | 0 | 0 | 0 | 0 |

TABLE 3

| | COMPARATIVE EXAMPLES | | | | | | | | |
|---|---|---|---|---|---|---|---|---|---|
| | a1 | a2 | a3 | a4 | a5 | a6 | a7 | a8 | a9 |
| EPOXY RESIN OF FORMULA (4) | | 6.91 | 6.91 | 6.96 | 6.28 | 6.94 | 6.25 | 6.96 | 6.96 |
| EPOXY RESIN OF FORMULA (7) | 6.31 | | | | | | | | |
| PHENOLIC RESIN OF FORMULA (6) | | 5.14 | 5.14 | 5.18 | 4.67 | 5.16 | 4.65 | 5.18 | 5.18 |
| PHENOLIC RESIN OF FORMULA (5) | 5.74 | | | | | | | | |
| DBU | 0.20 | 0.20 | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 | 87.00 | 87.00 |
| OXIDIZED POLYETHYLENE WAX No. 1 | 0.10 | | | 0.005 | 1.20 | 0.10 | 0.10 | 0.01 | 0.01 |
| POLYETHYLENE WAX No. 1 | | 0.10 | | | | | | | |
| POLYETHYLENE WAX No. 2 | | | 0.10 | | | | | | |
| γ-GLYCIDYLPROPYLTRIMETHOXYSILANE | 0.30 | 0.30 | 0.30 | 0.30 | 0.30 | 0.30 | 0.30 | 0.30 | 0.30 |
| 2,3-DIHYDROXYNAPHTHALENE | 0.05 | 0.05 | 0.05 | 0.05 | 0.05 | | 1.20 | | |
| 1,6-DIHYDROXYNAPHTHALENE | | | | | | | | 0.05 | |
| RESORCINOL | | | | | | | | | 0.05 |
| CARBON BLACK | 0.30 | 0.30 | 0.30 | 0.30 | 0.30 | 0.30 | 0.30 | 0.30 | 0.30 |
| SPIRAL FLOW (cm) | 130 | 105 | 115 | 120 | 90 | 65 | 170 | 75 | 70 |
| GOLD WIRE DEFORMATION RATIO | 0 | 0 | 0 | 0 | 0 | X | 0 | X | X |
| SEQUENTIAL MOLDABILITY | 0 | X | X | X | 0 | X | X | X | X |
| STAIN ON METAL MOLD SURFACE | 0 | X | X | 0 | X | 0 | X | 0 | 0 |
| STAIN ON MOLDED PRODUCT SURFACE | 0 | X | X | 0 | X | 0 | X | 0 | 0 |
| RESISTANCE TO REFLOW SOLDERING HEAT | X | X | X | X | X | 0 | 0 | X | X |

In any of Examples a1 to a23, superior results were obtained in terms of spiral flow and gold wire deformation ratio, so that it is confirmed that the epoxy resin composition for encapsulating the semiconductor chip has an improved flowability; and further it is also confirmed that the compound has an improved sequential moldability. Further, no stain was found on the surfaces of the molded product and the metal mold, so that it is confirmed that an improved mold releaseability for the metal mold is presented to of the molded product of the epoxy resin composition, and it is also confirmed that the compound has an improved resistance to reflow soldering heat.

On the contrary, in comparative example a1, in which epoxy resin presented by the general formula (4) and phenolic resin presented by the general formula (6) were not employed, the obtained compound failed to have lower water absorption and lower stress at higher temperature, resulting in deteriorated resistance to reflow soldering heat.

In addition, in comparative examples a2 and a3, in which (E1) oxidized polyethylene wax was not employed, sequential moldability (productivity) was deteriorated, and further, appearance of the molded product, stain on the metal mold and resistance to reflow soldering heat were deteriorated. In comparative example a4, in which blending quantity of the (E1) oxidized polyethylene wax was insufficient, reduction in mold-releaseability caused deteriorated sequential moldability and resistance to reflow soldering heat. In comparative example a5, in which blending quantity of the (E1) oxidized polyethylene wax was excessive, surplus components were bled at an interface with members and on the surface of the cured product, such that stain on the metal mold surface and stain on the surface of the molded product were confirmed. Further, resistance to reflow soldering heat was also deteriorated.

In comparative examples a6, a8 and a9, in which no (G) chemical compound was added therein, flowability of the resin composition was reduced, resulting in deteriorated gold wire deformation ratio. Further, in comparative example a8 and a9, resistance to reflow soldering heat was also reduced. In comparative example a7, in which blending quantity of (G) chemical compound was excessive, reduced sequential moldability (productivity) was caused by reduction in cure-ability of the resin composition, and further, stain on the molded product surface and stain on the metal mold surface were confirmed.

As described above, the epoxy resin composition for encapsulating the semiconductor chip of the present invention provides superior balancing of flowability, mold-releaseability and sequential moldability, and it is confirmed that an use of such resin composition provides a semiconductor device package having superior resistance to reflow soldering heat.

### Example B

### Example b1

Following raw materials were employed in example b1: [0133]

Epoxy resin represented by the above formula (4) (phenol aralkyl type epoxy resin having biphenylene skeleton), [commercially available from Nippon Kayaku Co, Ltd., under the trade name of “NC3000P”; having softening point of 58° C. and epoxy equivalent of 273]:

7.36 parts by weight.

Phenolic resin of the above-described formula (5) (phenol aralkyl resin having phenylene skeleton) [commercially available from Mitsui chemical Co., Ltd., under the trade name of XLC-4L, softening point of 65° C. and hydroxyl equivalent of 1741:

4.69 parts by weight.

DBU:

0.20 parts by weight.

fused spherical silica (mean particle diameter of 30.0 μm;

87.00 parts by weight.

glycerin trimontanic acid ester;

(commercially available from Clariant (Japan) K.K., under the trade name of “Licolub WE4”, dropping point of 82° C., acid value of 25 mg KOH/g, mean particle diameter of 45 μm, and content of particles having diameter of not smaller than 106 μm of 0.0 wt %):

0.10 part by weight.

y-glycidylpropyl trimethoxysilane;

0.30 part by weight,

2,3-dihydroxynaphthalene (reagent)

0.05 part by weight

carbon black

0.30 part by weight.

After mixing the raw materials listed above by using a mixer, the mixed material was kneaded for 20 times by using a biaxial roll having surface temperatures of 95° C. and 25° C., and thereafter, the obtained kneaded material sheet was cooled and then crushed to obtain an epoxy resin composition.

Characteristics of the obtained epoxy resin composition was evaluated by the method similar as employed in example A. Results are shown in table 4.

### Examples b2 to b15, and Comparative Examples b1 to b8

Respective components were mixed by the ratio described in table 4, table 5 and table 6, and epoxy resin compositions were obtained in similar way as in example b1, and evaluations thereof were conducted in similar way as in example b1.

Results are shown in table 4, table 5 and table 6. The components employed in examples other than example b1 will be described as follows:

glycerin tri melissic acid ester; (having dropping point of 95° C., acid value of 30 mg KOH/g, mean particle diameter of 45 μm, content of particles having diameter of not smaller than 106 μm of 0.0 wt % ).

glycerin tri behenic acid ester; (having dropping point of 80° C., acid value of 15 mg KOH/g, mean particle diameter of 45 μm, content of particles having diameter of not smaller than 106 μm of 0.0 wt % ) .

glycerin mono stearic acid ester; (commercially available from Riken Vitamin Co., Ltd., under the trade name of “Rikemal 5-100”, having dropping point of 65° C., acid value of 2 mg KOH/g, mean particle diameter of 45 μm, content of particles having diameter of not smaller than 106 μm of 0.0 wt %)

TABLE 4

| | EXAMPLES | | | | | | | |
|---|---|---|---|---|---|---|---|---|
| | b1 | b2 | b3 | b4 | b5 | b6 | b7 | b8 |
| EPOXY RESIN OF FORMULA (4) | 7.36 | | 6.91 | 6.92 | 6.88 | 6.80 | 6.65 | 6.48 |
| EPOXY RESIN OF FORMULA (7) | | 5.84 | | | | | | |
| PHENOLIC RESIN OF FORMULA (6) | | 6.21 | 5.14 | 5.15 | 5.12 | 5.05 | 4.95 | 4.82 |
| PHENOLIC RESIN OF FORMULA (5) | 4.69 | | | | | | | |
| DBU | 0.20 | 0.20 | 0.20 | 0.20 | 0.20 | 0.20 | 0.20 | 0.20 |
| FUSED SPHERICAL SILICA | 87.00 | 87.00 | 8700 | 87.00 | 87.00 | 87.00 | 87.00 | 87.00 |
| GLYCERIN TRIMONTANIC ACID ESTER | 0.10 | 0.10 | 0.10 | 0.10 | 0.10 | 0.10 | 0.10 | 0.10 |
| γ-GLYCIDYLPROPYLTRIMETHOXYSILANE | 0.30 | 0.30 | 0.30 | 0.30 | 0.30 | 0.30 | 0.30 | 0.30. |
| 2,3-DIHYDROXYNAPHTHALENE | 0.05 | 0.05 | 0.05 | 0.03 | 0.10 | 0.25 | 0.50 | 0.80 |
| CARBON BLACK | 0.30 | 0.30 | 0.30 | 0.30 | 0.30 | 0.30 | 0.30 | 0.30 |
| SPIRAL FLOW (cm) | 130 | 115 | 120 | 115 | 130 | 135 | 145 | 160 |
| GOLD WIRE DEFORMATION RATIO | 0 | 0 | 0 | 0 | 0 | 0 | 0 | 0 |
| SEQUENTIAL MOLDABILITY | 0 | 0 | 0 | 0 | 0 | 0 | 0 | 0 |
| STAIN ON METAL MOLD SURFACE | 0 | 0 | 0 | 0 | 0 | 0 | 0 | 0 |
| STAIN ON MOLDED PRODUCT SURFACE | 0 | 0 | 0 | 0 | 0 | 0 | 0 | 0 |
| RESISTANCE TO REFLOW SOLDERING | 0 | 0 | 0 | 0 | 0 | 0 | 0 | 0 |
| HEAT | | | | | | | | |

TABLE 5

| | EXAMPLES | | | | | | |
|---|---|---|---|---|---|---|---|
| | b9 | b10 | b11 | b12 | b13 | b14 | b15 |
| EPOXY RESIN OF FORMULA (4) | 6.91 | 6.91 | 6.91 | 6.95 | 6.68 | 6.91 | 6.91 |
| PHENOLIC RESIN OF FORMULA (6) | 5.14 | 5.14 | 5.14 | 5.17 | 4.97 | 5.14 | 5.14 |
| DBU | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.0 |
| GLYCERIN TRIMONTANIC ACID ESTER | 0.10 | 0.10 | 0.10 | 0.03 | 0.50 | | |
| GLYCERIN TRIMELISSIC ACID ESTER | | | | | | 0.10 | |
| GLYCERIN TRIBEHENIC ACID ESTER | | | | | | | 0.10 |
| γ-GLYCIDYLPROPYLTRIMETHOXYSILANE | 0.30 | 0.30 | 0.30 | 0.30 | 0.30 | 0.30 | 0.30 |
| 2,3-DIHYDROXYNAPHTHALENE | | | | 0.05 | 0.05 | 0.05 | 0.05 |
| 1,2-DIHYDROXYNAPHTHALENE | 0.05 | | | | | | |
| CATECHOL | | 0.05 | | | | | |
| PYROGALLOL | | | 0.05 | | | | |
| CARBON BLACK | 0.30 | 0.30 | 0.30 | 0.30 | 0.30 | 0.30 | 0.30 |
| SPIRAL FLOW (cm) | 120 | 125 | 130 | 115 | 135 | 120 | 115 |
| GOLD WIRE DEFORMATION RATIO | 0 | 0 | 0 | 0 | 0 | 0 | 0 |
| SEQUENTIAL MOLDABILITY | 0 | 0 | 0 | 0 | 0 | 0 | 0 |
| STAIN ON METAL MOLD SURFACE | 0 | 0 | 0 | 0 | 0 | 0 | 0 |
| STAIN ON MOLDED PRODUCT SURFACE | 0 | 0 | 0 | 0 | 0 | 0 | 0 |
| RESISTANCE TO REFLOW SOLDERING HEAT | 0 | 0 | 0 | 0 | 0 | 0 | 0 |

TABLE 6

| | COMPARATIVE EXAMPLES | | | | | | | |
|---|---|---|---|---|---|---|---|---|
| | b1 | b2 | b3 | b4 | b5 | b6 | b7 | b8 |
| EPOXY RESIN OF FORMULA (4) | | 6.91 | 6.96 | 6.28 | 6.94 | 6.25 | 6.91 | 6.91 |
| EPOXY RESIN OF FORMULA (7) | 6.31 | | | | | | | |
| PHENOLIC RESIN OF FORMULA (6) | | 5.14 | 5.18 | 4.67 | 5.16 | 4.65 | 5.14 | 5.14 |
| PHENOLIC RESIN OF FORMULA (5) | 5.74 | | | | | | | |
| DBU | 0.20 | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 | 87.00 |
| GLYCERIN TRIMONTANIC ACID ESTER | 0.10 | | 0.005 | 1.20 | 0.10 | 0.10 | 0.10 | 0.10 |
| GLYCERIN MONOSTEARIC ACID ESTER | | 0.10 | | | | | | |
| γ-GLYCIDYLPROPYLTRIMETHOXYSILANE | 0.30 | 0.30 | 0.30 | 0.30 | 0.30 | 0.30 | 0.30 | 0.30 |
| 2,3-DIHYDROXYNAPHTHALENE | 0.05 | 0.05 | 0.05 | 0.05 | | 1.20 | | |
| 1,6-DIHYDROXYNAPHTHALENE | | | | | | | 0.05 | |
| RESORCINOL | | | | | | | | 0.05 |
| CARBON BLACK | 0.30 | 0.30 | 0.30 | 0.30 | 0.30 | 0.30 | 0.30 | 0.30 |
| SPIRAL FLOW (cm) | 140 | 115 | 110 | 150 | 75 | 180 | 80 | 75 |
| GOLD WIRE DEFORMATION RATIO | 0 | 0 | 0 | 0 | X | 0 | X | X |
| SEQUENTIAL MOLDABILITY | 0 | X | X | 0 | X | X | X | X |
| STAIN ON METAL MOLD SURFACE | 0 | X | 0 | X | 0 | X | 0 | 0 |
| STAIN ON MOLDED PRODUCT SURFACE | 0 | X | 0 | X | 0 | X | 0 | 0 |
| RESISTANCE TO REFLOW SOLDERING HEAT | X | X | X | X | 0 | 0 | X | X |

In any of examples b1 to b15, superior results were obtained interms of spiral flow and gold wire deformation ratio, so that it is confirmed that the epoxy resin composition for encapsulating the semiconductor chip has an improved flowability, and further it is also confirmed that the compound has an improved sequential moldability. Further, no stain was found on the surfaces of the molded product and the metal mold, so that it is confirmed that an improved mold-releaseability for the metal mold is presented to of the molded product of the epoxy resin composition, and it is also confirmed that the compound has an improved resistance to reflow soldering heat.

On the contrary, in comparative example b1, in which no epoxy resin presented by the general formula (4), and no phenolic resin presented by the general formula (6), the obtained compound failed to have lower water absorption and lower stress at higher temperature, resulting in reduced resistance to reflow soldering heat.

In addition, in comparative example b2, in which no (E2) glycerin tri-fatty acid ester is employed, sequential moldability (productivity) was deteriorated, and further, appearance of the molded product, stain on the metal mold and resistance to reflow soldering heat were deteriorated. In comparative example b3, in which blending quantity of the (E2) glycerin tri-fatty acid ester was insufficient, reduction in mold-releaseability caused deteriorated sequential moldability and resistance to reflow soldering heat. In comparative example b4, in which blending quantity of the (E2) glycerin tri-fatty acid ester was excessive, surplus components were bled at an interface with members and on the surface of the cured product, such that stain on the metal mold surface and stain on the surface of the molded product were confirmed. Further, the resistance to reflow soldering heat was also deteriorated.

In comparative examples b5, b7 and b8, in which no (G) chemical compound was added therein, flowability of the resin composition was reduced, resulting in deteriorated gold wire deformation ratio. Further, in comparative example b7 and b8, resistance to reflow soldering heat was also reduced. In comparative example b6, in which blending quantity of (G) chemical compound was excessive, reduced sequential moldability (productivity) was caused by reduction in cure-ability of the resin composition, and further, stain on the molded product surface and stain on the metal mold surface were confirmed.

As described above, the epoxy resin composition for encapsulating the semiconductor chip of the present invention provides superior balancing of flowability, mold-releaseability and sequential moldability, and it is confirmed that an use of such resin composition provides a semiconductor device package having superior resistance to reflow soldering heat.

### Example C

### Example c1

Following raw materials were employed in example c1:

Epoxy resin represented by the above formula (4) (phenol aralkyl type epoxy resin having biphenylene skeleton); [commercially available from Nippon Kayaku Co, Ltd., under the trade name of “NC3000P”; having softening point of 58° C. and epoxy equivalent of 273],

7.36 parts by weight.

Phenolic resin of the above-described formula (5);(phenol aralkyl resin having phenylene skeleton [commercially available from Mitsui chemical Co., Ltd., under the trade name of XLC-4L, softening point of 65° C. and hydroxyl equivalent of 1741,

4.69 parts by weight.

DBU

0.20 part by weight.

fused spherical silica (mean particle diameter of 30.0 μm),

87.00 parts by weight.

Oxidized paraffin wax No. 1 (having softening point of 100° C., acid value of 15 mg KOH/g, mean particle diameter of 45 μm, content of particles having diameter of not smaller than 106 μm of 0.0 wt % ),

0.10 part by weight.

y-glycidyl propyl trimethoxysilane;

0.30 part by weight.

2,3-dihydroxynaphthalene (reagent);

0.05 part by weight.

carbon black;

0.30 part by weight.

After mixing the raw materials listed above by using a mixer, the mixed material was kneaded for 20 times by using a biaxial roll having surface temperatures of 95° C. and 25° C., and thereafter, the obtained kneaded material sheet was cooled and then crushed to obtain an epoxy resin composition.

Characteristics of the obtained epoxy resin composition was evaluated by the method similar as employed in example A.

Results are shown in table 7.

### Example c2 to c14, Comparative Example c1 to c8

Respective components were mixed by the ratio described in table 7, table 8 and table 9, and epoxy resin compositions were obtained in similar way as in example c1, and evaluations thereof were conducted in similar way as employed in example c1. Results are shown in table 7, table 8 and table 9.

Components employed in examples other than that listed above will be described as follows.

Oxidized paraffin wax No. 2; (having softening point of 105° C., acid value of 25 mg KOH/g, mean particle diameter of 45 μm, content of particles having diameter of not smaller than 106 μm of 0.0 wt % );

paraffin wax (having softening point of 70° C., acid value of 0 mg KOH/g, mean particle diameter of 45 μm, content of particles having diameter of not smaller than 106 μm of 0.0 wt %.

TABLE 7

| | EXAMPLES | | | | | | |
|---|---|---|---|---|---|---|---|
| | c1 | c2 | c3 | c4 | c5 | c6 | c7 |
| EPOXY RESIN OF FORMULA (4) | 7.36 | | 6.91 | 6.92 | 6.88 | 6.80 | 6.65 |
| EPOXY RESIN OF FORMULA (7) | | 5.84 | | | | | |
| PHENOLIC RESIN OF FORMULA (6) | | 6.21 | 5.14 | 5.15 | 5.12 | 5.05 | 4.95 |
| PHENOLIC RESIN OF FORMULA (5) | 4.69 | | | | | | |
| DBU | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 |
| OXIDIZED PARAFFIN WAX No. 1 | 0.10 | 0.10 | 0.10 | 0.10 | 0.10 | 0.10 | 0.10 |
| γ-GLYCIDYLPROPYLTRIMETHOXYSILANE | 0.30 | 0.30 | 0.30 | 0.30 | 0.30 | 0.30 | 0.30 |
| 2,3-DIHYDROXYNAPHTHALENE | 0.05 | 0.05 | 0.05 | 0.03 | 0.10 | 0.25 | 0.50 |
| CARBON BLACK | 0.30 | 0.30 | 0.30 | 0.30 | 0.30 | 0.30 | 0.30 |
| SPIRAL FLOW (cm) | 125 | 110 | 115 | 110 | 125 | 130 | 140 |
| GOLD WIRE DEFORMATION RATIO | 0 | 0 | 0 | 0 | 0 | 0 | 0 |
| SEQUENTIAL MOLDABILITY | 0 | 0 | 0 | 0 | 0 | 0 | 0 |
| STAIN ON METAL MOLD SURFACE | 0 | 0 | 0 | 0 | 0 | 0 | 0 |
| STAIN ON MOLDED PRODUCT SURFACE | 0 | 0 | 0 | 0 | 0 | 0 | 0 |
| RESISTANCE TO REFLOW SOLDERING HEAT | 0 | 0 | 0 | 0 | 0 | 0 | 0 |

TABLE 8

| | EXAMPLES | | | | | | |
|---|---|---|---|---|---|---|---|
| | c8 | c9 | c10 | c11 | c12 | c13 | c14 |
| EPOXY RESIN OF FORMULA (4) | 6.48 | 6.91 | 6.91 | 6.91 | 6.95 | 6.68 | 6.91 |
| PHENOLIC RESIN OF FORMULA (6) | 4.82 | 5.14 | 5.14 | 5.14 | 5.17 | 4.97 | 5.14 |
| DBU | 0.20 | 0.20 | 0.20 | 0.20 | 0.20 | 020 | 0.20 |
| FUSED SPHERICAL SILICA | 87.00 | 87.00 | 87.00 | 87.00 | 87.00 | 87.00 | 87.00 |
| OXIDIZED PARAFFIN WAX No. 1 | 0.10 | 0.10 | 0.10 | 0.10 | 0.03 | 0.50 | |
| OXIDIZED PARAFFIN WAX No. 2 | | | | | | | 0.10 |
| γ-GLYCIDYLPROPYLTRIMETHOXYSILANE | 0.30 | 0.30 | 0.30 | 0.30 | 0.30 | 0.30 | 0.30 |
| 2,3-DIHYDROXYNAPHTHALENE | 0.80 | | | | 0.05 | 0.05 | 0.05 |
| 1,2-DIHYDROXYNAPHTHALENE | | 0.05 | | | | | |
| CATECHOL | | | 0.05 | | | | |
| PYROGALLOL | | | | 0.05 | | | |
| CARBON BLACK | 0.30 | 0.30 | 0.30 | 0.30 | 0.30 | 0.30 | 0.30 |
| SPIRAL FLOW (cm) | 155 | 115 | 120 | 125 | 110 | 135 | 110 |
| GOLD WIRE DEFORMATION RATIO | 0 | 0 | 0 | 0 | 0 | 0 | 0 |
| SEQUENTIAL MOLDABILITY | 0 | 0 | 0 | 0 | 0 | 0 | 0 |
| STAIN ON METAL MOLD SURFACE | 0 | 0 | 0 | 0 | 0 | 0 | 0 |
| STAIN ON MOLDED PRODUCT SURFACE | 0 | 0 | 0 | 0 | 0 | 0 | 0 |
| RESISTANCE TO REFLOW SOLDERING HEAT | 0 | 0 | 0 | 0 | 0 | 0 | 0 |

TABLE 9

| | COMPARATIVE EXAMPLES | | | | | | | |
|---|---|---|---|---|---|---|---|---|
| | c1 | c2 | c3 | c4 | c5 | c6 | c7 | c8 |
| EPOXY RESIN OF FORMULA (4) | | 6.91 | 696 | 6.28 | 6.94 | 6.25 | 6.91 | 6.91 |
| EPOXY RESIN OF FORMULA (7) | 6.31 | | | | | | | |
| PHENOLIC RESIN OF FORMULA (6) | | 5.14 | 5.18 | 4.67 | 5.16 | 4.65 | 5.14 | 5.14 |
| PHENOLIC RESIN OF FORMULA (5) | 5.74 | | | | | | | |
| DBU | 0.20 | 0.20 | 0.20 | 0.20 | 0.20 | 0.20 | 0.20 | 0.20 |
| FUSED SPHERICAL SILICA | 87.00 | 87.00 | 87.00 | 87.00 | 87.00 | 87.00 | 87.00 | 87.00 |
| OXIDIZED PARAFFIN WAX No. 1 | 0.10 | | 0.005 | 1.20 | 0.10 | 0.10 | 0.10 | 0.10 |
| PARAFFIN WAX | | 0.10 | | | | | | |
| γ-GLYCIDYLPROPYLTRIMETHOXYSILANE | 0.30 | 0.30 | 0.30 | 0.30 | 0.30 | 0.30 | 0.30 | 0.30 |
| 2,3-DIHYDROXYNAPHTHALENE | 0.05 | 0.05 | 0.05 | 0.05 | | 1.20 | | |
| 1,6-DIHYDROXYNAPHTHALENE | | | | | | | 0.05 | |
| RESORCINOL | | | | | | | | 0.05 |
| CARBON BLACK | 0.30 | 0.30 | 0.30 | 0.30 | 0.30 | 0.30 | 0.30 | 0.30 |
| SPIRAL FLOW (cm) | 135 | 110 | 105 | 145 | 70 | 175 | 75 | 70 |
| GOLD WIRE DEFORMATION RATIO | 0 | 0 | 0 | 0 | X | 0 | X | X |
| SEQUENTIAL MOLDABILITY | 0 | X | X | 0 | X | X | X | X |
| STAIN ON METAL MOLD SURFACE | 0 | X | 0 | X | 0 | X | 0 | 0 |
| STAIN ON MOLDED PRODUCT SURFACE | 0 | X | 0 | X | 0 | X | 0 | 0 |
| RESISTANCE TO REFLOW SOLDERING HEAT | X | X | X | X | 0 | 0 | X | X |

In any of Examples cl to c14, superior results were obtained in terms of spiral flow and gold wire deformation ratio, so that it is confirmed that the epoxy resin composition for encapsulating the semiconductor chip has an improved flowability, and further it is also confirmed that the compound has an improved sequential moldability. Further, no stain was found on the surfaces of the molded product and the metal mold, so that it is confirmed that an improved mold-releaseability for the metal mold is presented to of the molded product of the epoxy resin composition, and it is also confirmed that the compound has an improved resistance to reflow soldering heat.

On the contrary, in comparative example c1, in which epoxy resin presented by the general formula (4) and phenolic resin presented by the general formula (6) were not employed, the obtained compound failed to have lower water absorption and lower stress at higher temperature, resulting in reduced resistance to reflow soldering heat.

In addition, in comparative example c2, in which (E3) oxidized paraffin wax was not employed, sequential moldability (productivity) was deteriorated, and further, appearance of the molded product, stain on the metal mold and resistance to reflow soldering heat were deteriorated. In comparative example c3, in which content of the (E3) oxidized paraffin wax was insufficient, reduction in mold-releaseability caused deteriorated sequential moldability and resistance to reflow soldering heat. In comparative example c4, in which blending quantity of the (E3) oxidized paraffin wax was excessive surplus components were bled at an interface with members and on the surface of the cured product, such that stain on the metal mold surface and stain on the surface of the molded product were confirmed.

Further, resistance to reflow soldering heat was also deteriorated.

In comparative examples c5, c7 and c8, in which no (G) chemical compound was added therein, flowability of the resin composition was reduced, resulting in deteriorated gold wire deformation ratio.

Further, in comparative example c7 and c8, resistance to reflow soldering heat was also reduced.

In comparative example c6, in which blending quantity of (G) chemical compound was excessive, reduced sequential moldability (productivity) was caused by reduction in cure-ability of the resin composition, and further, stain on the molded product surface and stain on the metal mold surface were confirmed.

As described above, the epoxy resin composition for encapsulating the semiconductor chip of the present invention provides superior balancing of flowability, mold-releaseability and sequential moldability, and it is confirmed that an use of such resin composition provides a semiconductor device package having superior resistance to reflow soldering heat.

The epoxy resin composition for encapsulating the semiconductor chip according to the present invention has an improved flowability, an improved mold-releaseability, an improved sequential moldability and the like, and additionally has improved characteristics of a cured product thereof, such as an improved resistance to reflow soldering heat and the like.

Therefore, the resin composition can be preferably employed as a material for encapsulating a semiconductor chip, and further, a semiconductor device that is formed by encapsulating a semiconductor chip with the resin composition can be provided.

What is claimed is:

1. An epoxy resin composition for encapsulating a semiconductor chip, including:
(A) an epoxy resin;
(B) a phenolic resin;
(C) a cure accelerator;
(D) an inorganic filler;
(E) a mold releasing agent;
(F) a silane coupling agent; and
(G) a chemical compound having aromatic ring that has hydroxyl groups, each of which is bound to respective two or more adjacent carbon atoms that composes said aromatic ring,
wherein at least one of said (A) epoxy resin and said (B) phenolic resin contains a resin presented by the following general formula (1) : 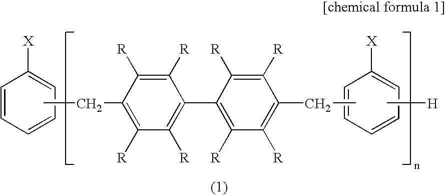
(wherein plurality of R, which are same or different, represent functional group(s) selected from a group consisting of hydrogen atom and alkyl groups having one to four carbon(s); X represents glycidyl ether group or hydroxyl group; and n represents an average value that is a positive number within a range of from 1 to 3),
wherein said (E) mold releasing agent includes one or more compound(s) selected from a group consisting of (E1) an oxidized polyethylene wax, (E2) a glycerin tri-fatty acid ester and (E3) an oxidized paraffin wax, and
wherein said (E) mold releasing agent is contained in the amount of 0.01 wt % to 1 wt % both inclusive, and said (G) chemical compound is contained in the amount of 0.01 wt % to 1 wt % both inclusive, in the total epoxy resin composition.

2. The epoxy resin composition for encapsulating the semiconductor chip according to claim 1, wherein said (G) chemicalcompound is presented by the following general formula (2): 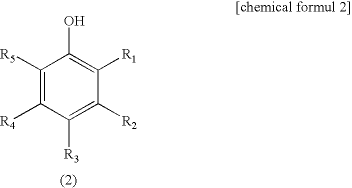
(wherein one of R1 and R5 is hydroxyl group, and the other is hydrogen atom, hydroxyl group or substitutional group other than hydroxyl group, each of R2, R3 and R4 is independently hydrogen atom, hydroxyl group or substitutional group other than hydroxyl group, or R2 and R3, R3 and R4 are combined to form aromatic ring).

3. The epoxy resin composition for encapsulating the semiconductor chip according to claim 1, wherein said (E) mold releasing agent is (E1) the oxidized polyethylene wax.

4. The epoxy resin composition for encapsulating the semiconductor chip according to claim 3, wherein dropping point of said (E1) oxidized polyethylene wax is within a range of from 100° C. to 140° C. both inclusive.

5. The epoxy resin composition for encapsulating the semiconductor chip according to claim 3, wherein mean particle diameter of said (E1) oxidized polyethylene wax is within a range of from 20 μm to 70 μm both inclusive, and content of the particles having particle diameters of equal to or larger than 106 μm in the total (E1) oxidized polyethylene wax is equal to or less than 0.1 wt %

6. The epoxy resin composition for encapsulating the semiconductor chip according to claim 3, wherein acid value of said (E1) oxidized polyethylene wax is within a range of from 10 mg KOH/g to 50 mg KOH/g both inclusive.

7. The epoxy resin composition for encapsulating the semiconductor chip according to claim 3, wherein number average molecular weight of said (E1) oxidized polyethylene wax is within a range of from 500 to 5,000 both inclusive.

8. The epoxy resin composition for encapsulating the semiconductor chip according to claim 3, wherein density of said (E1) oxidized polyethylene wax is within a range of from 0.94 g/cm3 to 1.03 g/cm³ both inclusive.

9. The epoxy resin composition for encapsulating the semiconductor chip according to claim 3, wherein said (E1) oxidized polyethylene wax includes one or more oxide(s) selected from a group consisting of: an oxide of a polyethylene wax produced via a low pressure polymerization process; an oxide of a polyethylene wax produced via a high pressure polymerization process; and an oxide of a high density polyethylene polymer.

10. The epoxy resin composition for encapsulating the semiconductor chip according to claim 1, wherein said (E) mold releasing agent is (E2) a glycerin tri-fatty acid ester.

11. The epoxy resin composition for encapsulating the semiconductor chip according to claim 10, wherein a dropping point of said (E2) glycerin tri-fatty acid ester is within a range of from 70° C. to 120° C. both inclusive.

12. The epoxy resin composition for encapsulating the semiconductor chip according to claim 10, wherein mean particle diameter of said (E2) glycerin tri-fatty acid ester is within a range of from 20 μm to 70 μm both inclusive, and content of the particles having particle diameters of equal to or larger than 106 μm in the total (E2) glycerin tri-fatty acid ester is equal to or less than 0.1 wt %.

13. The epoxy resin composition for encapsulating the semiconductor chip according to claim 10, wherein acid value of said (E2) glycerin tri-fatty acid ester is within a range of from 10 mg KOH/g to 50 mg KOH/g both inclusive.

14. The epoxy resin composition for encapsulating the semiconductor chip according to claim 10, wherein said (E2) glycerin tri-fatty acid ester is a tri-ester compound of glycerin and saturated fatty acid having 24 to 36 carbon atoms.

15. The epoxy resin composition for encapsulating the semiconductor chip according to claim 1, wherein said (E) mold releasing agent is (E3) an oxidized paraffin wax.

16. The epoxy resin composition for encapsulating the semiconductor chip according to claim 15, wherein softening point of said (E3) oxidized paraffin wax is within a range of from 70° C. to 120° C. both inclusive.

17. The epoxy resin composition for encapsulating the semiconductor chip according to claim 15, wherein mean particle diameter of said (E3) oxidized paraffin wax is within a range of from 20 μm to 70 μm both inclusive, and content of the particles having particle diameters of equal to or larger than 106 μm in the total oxidized paraffin wax is equal to or less than 0.1 wt %

18. The epoxy resin composition for encapsulating the semiconductor chip according to claim 15, wherein said value of said (E3) oxidized paraffin wax is within a range of from 10 mg KOH/g to 50mg KOH/g both inclusive.

19. A semiconductor device, provided by encapsulating a semiconductor chip with the epoxy resin composition for encapsulating the semiconductor chip according to claim 1.
